(19) United States
(12) Patent Application Publication
(10) Pub. No.: US 2015/0265864 A1
(43) Pub. Date: Sep. 24, 2015

(54) NOZZLE ASSEMBLY

(71) Applicant: S.P.A. Automotive Limited, Lichfield (GB)

(72) Inventors: Richard BARNES, Lichfield (GB); Tony TAYLOR, Lichfield (GB); Edward CHERRY, Lichfield (GB)

(21) Appl. No.: 14/615,589

(22) Filed: Feb. 6, 2015

(30) Foreign Application Priority Data
Feb. 6, 2014 (GB) 1402021.8

(51) Int. Cl. A62C 35/68; B05B 1/30; A62C 3/07

(52) U.S. Cl. CPC A62C 35/68; A62C 3/07; B05B 1/30

(57) ABSTRACT

A nozzle assembly (1) for controlling the release or delivery of a fluid or other medium from a vessel. The nozzle assembly (1) comprises a body (2) having a longitudinal and latitudinal dimension and having an inlet (6) and a plural outlets (24a, 24b, 24c), release means (4) and valve means (5) operable to selectively open or close fluid communication between the inlet (6) and the outlets (24a, 24b, 24c), wherein the valve means (5) is biased, in use, toward an open position or condition such that operation of the release means (4) causes or permits the valve means (5) to move or change to the open position or condition, fluid being flowable with the valve means (5) in the open position or condition, from the inlet (6) to the outlets (24a, 24b, 24c) and flowing from the outlets (24a, 24b, 24c) in different directions to define a flow or spray pattern which subtends an angle of less than 360° in both the longitudinal and latitudinal directions.

### FIELD OF THE INVENTION

This invention relates generally to nozzle assemblies and more particularly to a nozzle assembly for controlling and/or directing the release or delivery of a fluid or other medium. More specifically, although not exclusively, this invention relates to a nozzle assembly for incorporation into the delivery device of a pressurised vessel.

This invention is particularly, although not exclusively, concerned with such nozzle assemblies for use with emergency equipment, for example fire extinguishing equipment or devices, which may be used or fitted in offices, factories, houses or in vehicles such as racing or competition cars, speedboats and aircraft. The nozzle assembly may have particular utility in vehicles, for example vehicles used for racing or competition.

### BACKGROUND OF THE INVENTION

It is known to fit a fire extinguishing device in a vehicle that includes a pressurised vessel or tank containing an extinguishing medium and a distribution head connected to pipes that distribute and deliver the extinguishing medium to likely fire sites, for example the engine or cockpit. The distribution head generally includes a valve for selectively releasing the extinguishing medium from the vessel to the pipes.

GB2305120 discloses one such device in which the orientation of the pipe union is angularly movable relative to the tank. This arrangement simplifies by virtue of its adjustability the fitting of the device in a vehicle or the modification of the device after fitting in the vehicle. Delivery of the extinguishing medium to the likely fire sites is done by virtue of a series of nozzles connected to the end of the pipes.

Whilst this arrangement facilitates fitting and adaptation of the fire extinguishing system, there is a need to simplify the installation further, to reduce the time and effort required for fitting. The applicants have also determined that it would be advantageous to provide controlled delivery of the medium to multiple locations from a single pressure vessel. It may also be beneficial to maintain a small profile of assembly.

### OBJECTS OF THE INVENTION

It is therefore a first non-exclusive object of the invention to provide a simpler and/or more effective means of delivering a fluid or other medium from a pressure vessel to a particular area.

It is a second non-exclusive object of the invention to provide an improved means of providing controlled delivery of a fluid or other medium from a pressurised vessel to any one of two or more predetermined areas.

It is a yet further, more general non-exclusive object of the invention to provide an improved nozzle assembly for controllably releasing or delivering a fluid or other medium from a pressurised vessel.

### SUMMARY OF THE INVENTION

Accordingly, a first aspect of the invention provides a nozzle assembly, e.g. for controlling the release or delivery of a fluid or other medium from a vessel, the nozzle assembly comprising a body having longitudinal and latitudinal dimensions and having an inlet and plural outlets, release means and valve means operable to selectively open or close fluid communication between the inlet and the outlets, wherein the valve means is biased, in use, toward an open or a closed position or condition such that operation of the release means causes or allows or permits the valve means to move or change to the position or condition toward which it is biased, fluid being flowable, with the valve in the open position or condition, from the inlet to the outlets and flowing from the outlets in different directions to define a flow or spray pattern which subtends an angle of less than 360° in both the longitudinal and latitudinal directions.

The outlets may be positioned and located so as to define a flow or spray pattern which subtends an angle of less than 350, 340, 330, 320, 310, 300, 290, 280, 270, 260, 250, 240, 230, 220, 210, 200° in one or both of the latitudinal and longitudinal directions. The outlets may be positioned and located so as to define a flow or spray pattern which subtends an angle of from 90° to less than 360° in one or both of the latitudinal and longitudinal directions, for example an angle of 100° to 300° , say 110° to 270° , and preferably 120° to 250°

The body may comprise a base and a periphery, with the inlet and plural outlets extending into and out of the periphery, the base being securable to a site of use, the plural outlets causing fluid flowing therefrom to generate a flow pattern which extends away from the base in at least three directions.

The valve means is preferably biased, in use, toward the open position or condition. Alternatively, the valve means may be biased, in use, toward the closed position or condition.

Preferably, the nozzle assembly comprises two or more outlets, e.g. for releasing or delivering a fluid or other medium therefrom in at least two different directions. The two or more outlets may comprise three or more, for example four or more, e.g. a plurality of, outlets, e.g. for releasing or delivering a fluid or other medium therefrom in at a plurality of different directions. In some embodiments, each outlet is configured for releasing or delivering a fluid or other medium therefrom in a direction different to that of the other outlets, e.g. each of the other outlets.

One or more of the outlets may comprise a radial outlet and/or extend at least in part in a radial direction and/or may be configured to release or deliver a fluid or other medium radially, e.g. from or with respect to the body. In some embodiments, the body comprises a central or axial passage or passageway or bore or inlet, for example with two or three or four or more, e.g. a plurality of, radial outlets extending therefrom and/or fluidly connected or connectable therewith.

Additionally or alternatively, one or more of the outlets may comprise a tangential outlet and/or may extend at least in part in a tangential direction. For example, one or more of the outlets may be configured to release or deliver a fluid or other medium tangentially, e.g. from or with respect to the body or with respect to an axial or longitudinal direction of the body, or from or with respect to the or a central or axial passage or passageway or bore or inlet of the body, for example with respect to an axial or longitudinal direction thereof. In some embodiments, the body comprises a central or axial passage or passageway or bore or inlet with one or more outlets or outlet passages or passageways at least a portion of which extends tangentially therefrom and/or with respect thereto or with respect to an axial direction thereof. At least part of the body may be rotatable with respect to the inlet and/or rotatably mountable, e.g. arranged to be mounted such that it is rotatable, preferably about the axial or longitudinal direction of the body or central or axial passage or passageway or bore or inlet of the body, for example a stationary part of the body that may include or incorporate the inlet.

In some embodiments, one or more of the outlets comprises a tangential outlet and/or extends at least in part in a tangential direction and at least part of the body is rotatable, in use, about the axial or longitudinal direction of the body or central or axial passage or passageway or bore or inlet of the body such that extinguishing medium is expelled from the outlets tangentially, thereby causing the rotatable part of the body to rotate.

A second aspect of the invention provides a nozzle assembly, e.g. for controlling the release or delivery of a fluid or other medium from a vessel, the nozzle assembly comprising a body with an inlet and one or more outlets at least one of which outlets extends at least in part in a tangential direction, release means and valve means operable to selectively open or close fluid communication between the inlet and the outlet, wherein at least part of the body is rotatable, in use, such that operation of the release means causes or allows or permits the valve means to move or change to an open position or condition to release or expel extinguishing medium from the outlets tangentially, thereby causing the rotatable part of the body to rotate.

For the avoidance of doubt, any of the features described herein apply equally to any aspect of the invention.

Additionally or alternatively, one or more of the outlets may extend at least in part at an angle with respect to the or a longitudinal direction or central or axial passage or passageway or bore or inlet and/or at an angle with respect to the or a radial direction. For example, one or more of the outlets may be configured to release or deliver a fluid or other medium at an angle, e.g. an acute or oblique angle, from or with respect to an axial and/or longitudinal direction of the body or of the or a central or axial passage or passageway or bore or inlet of the body. One or more of the outlets may extend at least in part in a direction between the direction of the axial passage and a direction orthogonal thereto.

Additionally or alternatively, the nozzle assembly may comprise plural outlets wherein the plural outlets are arranged in plural arrays, each of the arrays being distributed at a different longitudinal location. Additionally or alternatively the outlets in an array may be distributed at different latitudinal locations. The arrays may comprise the same or different number of outlets.

In one embodiment the body comprises at least plural arrays of outlets, the first of the plural arrays being located toward the inlet and a second of the arrays being located relatively longitudinally away from the inlet, the second or the arrays having or comprising a greater number of outlets than the first of the arrays, and/or having, in use a greater fluid throughput rate than the first of the arrays.

The body may comprise any suitable shape, for example cylindrical or conical or frustoconical and/or with a round or elliptical or polygonal or triangular or square or rectangular or pentagonal or hexagonal or octagonal cross-section. Additionally or alternatively, the body may comprise a tubular member, for example with a central or axial passage or passageway or bore or inlet that may extend through at least part, e.g. the entire length thereof. The nozzle assembly may further comprise a pipe fitting, e.g. for connection with a pipe fluidly connected to a pressurised vessel or for coupling to a port, e.g. a threaded port of, a pressurised vessel directly.

The valve means may comprise a valve element or member or piston, which may be received, for example sealingly and/or movably and/or rotatably and/or translatably received, within the body, e.g. within the or a central or axial passage or passageway or bore or inlet of the body. The valve means may be movable or changeable, such as by translation or rotation, between the open position or condition, for example in which fluid communication between the inlet and the outlets is open, and a closed position or condition, e.g. in which fluid communication between the inlet and the outlets is closed.

The valve means may be biased by a biaser or biasing means, which may comprise a pressurised fluid or medium, e.g. within a pressurised vessel to which the valve assembly is mounted, in use, or with which the valve assembly is associated, and/or a resilient biaser or biasing means such as a spring or resilient element or member.

The nozzle assembly or release means may comprise an abutment means, which may be breakable or frangible or severable or movable or changeable between a deployed or stop position or condition, for example in which the valve means may be biased thereagainst, e.g. and inhibited from moving or opening or closing, and an undeployed or retracted or release or released or open position or condition, e.g. in which the valve means may be able to open or close or move uninhibited. Additionally or alternatively, the nozzle assembly or release means may comprise an activation means, e.g. for operating the release means or the abutment means or for causing it to break or to move or change between the deployed or stop position or condition and the undeployed or retracted or release or released or open position or condition.

In one preferred embodiment, the nozzle assembly or release means or abutment means comprises a breakable or frangible or severable element or member or bulb, e.g. a glass bulb, against which the valve means abuts, for example wherein the valve member is caused or allowed or permitted to move or change to the open or closed position or condition when the breakable or frangible or severable element or member or bulb is broken or severed.

Additionally or alternatively, the nozzle assembly or release means or abutment means may comprise a movable or removable release element or member, such as a rod, plate or pin, e.g. for manually operating or overriding the breakable or frangible or severable element or member or bulb. The movable or removable release element or member may be configured to selectively retain, or inhibit movement of, the valve means or the breakable or frangible or severable element or member or bulb. In some embodiments, the movable or removable release element or member selectively retains the breakable or frangible or severable element or member or bulb in the deployed or stop position, e.g. wherein the valve means is biased thereagainst. Additionally or alternatively, removal of the release element or member may cause or allow or permit the valve means to move or change to the open or closed position or condition, for example by allowing the breakable or frangible or severable element or member or bulb to move or break or be severed or by moving or breaking or severing the breakable or frangible or severable element or member or bulb. The removable release element or member may comprise manual actuation means.

The nozzle assembly may further comprise a retaining clip, which may be engageable with the movable or removable release element or member or rod or plate or pin and/or may selectively inhibit movement or removal thereof. In some embodiments, the movable or removable release element or member or rod or plate or pin may comprise a hole or aperture or recess or depression within which at least a portion of the retaining clip may be received. The retaining clip may comprise a spring clip, for example an R spring clip or an R shaped spring clip.

The nozzle assembly may further comprise an elongate member or cable or lanyard, which may be engageable with the movable or removable release element or member or rod or plate or pin. In some embodiments, the movable or removable release element or member or rod or plate or pin may comprise a hole or aperture or recess or depression within which at least a portion of the elongate member or cable or lanyard may be received. In one preferred embodiment, the elongate member or cable or lanyard defines or forms or is formed into a loop, which loop may be received within the or a hole or aperture or recess or depression of the elongate member or cable or lanyard. The elongate member or cable or lanyard may be configured or installed, in use, to enable remote operation of the movable or removable release element or member or rod or plate or pin.

A further aspect of the invention provides a nozzle assembly for controlling the release or delivery of a fluid or other medium from a vessel, the nozzle assembly comprising a body having a base and a periphery, an inlet and plural outlets extending into and out of the periphery, the base being securable to a site of use, release means and valve means operable to selectively open or close fluid communication between the inlet and the outlets, wherein the valve means is biased, in use, toward an open position or condition such that operation of the release means causes or permits the valve means to move or change to the open position or condition, and wherein the plural outlets cause fluid flowing therefrom to generate a flow pattern which extends away from the base in at least three directions.

The provision of a base portion for securing the assembly to a site of use which is not co-aligned with the inlet allows is, we believe, advantageous because it ensures a low profile of the assembly and an appropriate coverage, in use.

A further aspect of the invention provides a nozzle assembly, e.g. for controlling the release or delivery of a fluid or other medium from a vessel, the nozzle assembly comprising an inlet, one or more outlets, release means and valve means operable to selectively open or close fluid communication between the inlet and the outlet, wherein the valve means is biased, in use, toward an open or a closed position or condition such that operation of the release means causes or allows or permits the valve means to move or change to the position or condition toward which it is biased.

The valve means is preferably biased, in use, toward the open position or condition. Alternatively, the valve means may be biased, in use, toward the closed position or condition.

Preferably, the nozzle assembly comprises two or more outlets, e.g. for releasing or delivering a fluid or other medium therefrom in at least two different directions. The two or more outlets may comprise three or more, for example four or more, e.g. a plurality of, outlets, e.g. for releasing or delivering a fluid or other medium therefrom in at a plurality of different directions. In some embodiments, each outlet is configured for releasing or delivering a fluid or other medium therefrom in a direction different to that of the other outlets, e.g. each of the other outlets.

Further aspects of the invention provide a vessel containing a pressurised fluid or medium, which may comprise an extinguishing fluid or medium, and a fire extinguisher or fire extinguishing device, each of which may comprise the nozzle assembly described above.

Yet further aspects of the invention provide a kit of parts for assembly into a nozzle assembly and/or a vessel and/or a fire extinguisher as described above and a method of assembling and/or operating a nozzle assembly as described above.

A yet further aspect of the invention provides a vehicle in which the aforementioned nozzle assembly or vessel or fire extinguisher or fire extinguishing device is mounted or fitted. The nozzle assembly may be mounted or fitted in the cockpit, but it is preferably mounted or fitted in a position spaced from or remote from the cockpit, for example in or at or on the front or rear of the vehicle. In some embodiments, the nozzle assembly is mounted or fitted in the boot or trunk of the vehicle, for example where the vehicle is an automobile or a motorsport vehicle or automobile. Additionally or alternatively, the or a further nozzle assembly may be mounted or fitted under the bonnet or hood of the vehicle, for example where the vehicle is an automobile or a motorsport vehicle or automobile.

### BRIEF DESCRIPTION OF THE DRAWINGS

Embodiments of the invention will now be described by way of example only with reference to the accompanying drawings in which:

FIG. 1 is a perspective view of a nozzle assembly according to one embodiment of the invention;

FIG. 1A is a partial perspective view of the nozzle assembly shown in FIG. 1;

FIG. 1B is a sectional view taken along the plane indicated by line X-X in FIG. 1A; and

FIG. 2 is an exploded top view of the nozzle assembly of FIG. 1.

### DESCRIPTION OF THE INVENTION

Referring now to the Figures, there is shown a nozzle assembly 1 for controlling the release or delivery of a fluid or other medium from a pressurised vessel (not shown). The nozzle assembly 1 includes a body 2, an end cap 3, a release assembly 4, a valve piston 5 and a pipe fitting 6.

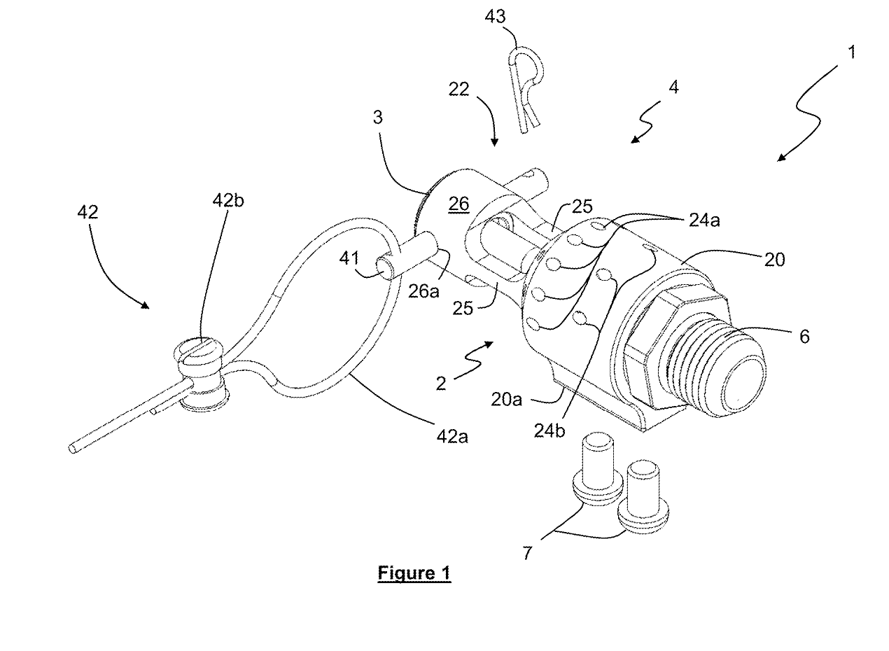

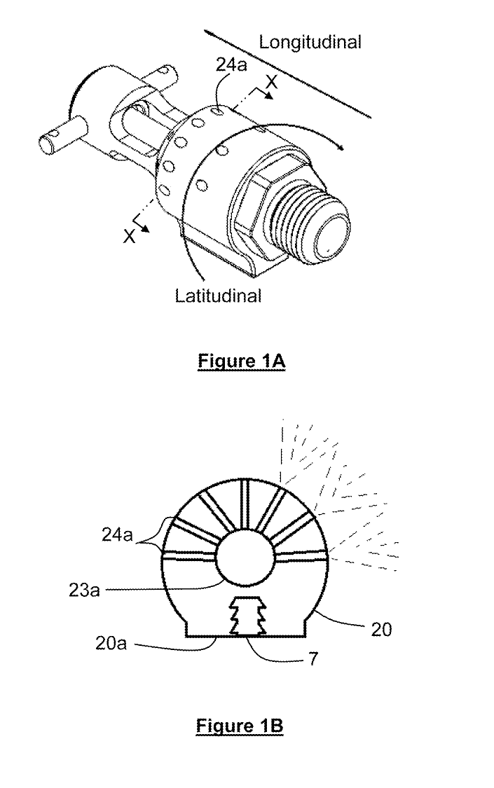

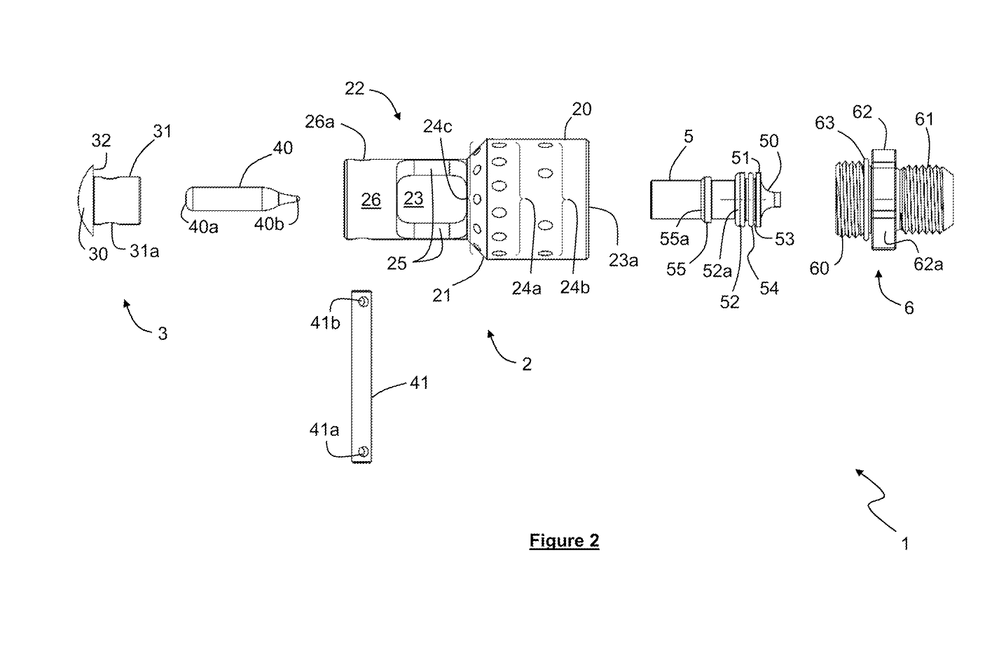

The body 2 (which has longitudinal and latitudinal dimensions, as shown in FIG. 1A) is substantially cylindrical in shape with a base portion 20, a tapered portion 21 and a release portion 22. The base portion 20 is substantially cylindrical with a flat portion 20a and includes an axial bore 23 with an internally threaded inlet 23a in the base portion 20, a first row or array of outlets 24a extending radially with respect to the axis of the axial bore 23 and a second row or array of outlets 24b that extend in an upstream or rearward direction at an angle between the axis of the axial bore 23 and the radial outlets 24a. The tapered portion 21 includes a third row or array of outlets 24c that also extend in a downstream or forward direction at an angle between the axis of the axial bore 23 and the radial outlets 24a. The outlets 24a, 24b, 24c are therefore configured to expel extinguishing medium in multiple directions to ensure the required coverage (as shown in FIG. 1B) in both the latitudinal and longitudinal directions.

The first array 24a comprises a greater number of outlets than the second array 24b, which is located closer to the inlet. Instead of a greater number of outlets the outlets 24a may have a larger bore than those of the second array of outlets 24b. In either or any case, it is preferred that the array of outlets in closer proximity to the inlet has a lower fluid flow-through rate than the outlets more distant to the inlet. In a confined space, (such as may be experienced in a vehicle such as a racing car) the inlet is likely to be mounted near a wall or other abutment and so the greater flow of fluid should be directed away from that wall or abutment.

The release portion 22 of the body 2 includes a pair of opposed arm portions 25 joining the tapered portion 21 to a tubular end portion 26. The end portion 26 is cylindrical with a diameter that is smaller than that of the base portion 20 and includes a radial bore 26a.

The end cap 3 includes a solid hemispherical portion 30 and a tubular cylindrical portion 31 extending from a flat surface 32 thereof. The tubular cylindrical portion 31 is sized to fit within the tubular end portion 26 of the body 2 and includes a radial bore 31a having substantially the same size and configuration as the radial bore 26a of the tubular end portion 26.

The release assembly 4 includes a frangible bulb 40, a manual release pin 41, a lanyard 42 and an R-clip 43. The frangible bulb 40 is cylindrical in shape with a first, hemispherical end 40a and a second end with an axial projection 40b. The frangible bulb 40 is a heat-sensitive glass bulb containing a fluid with a predetermined thermal expansion coefficient selected such that at a given temperature, the thermal expansion of the fluid causes the bulb 40 to break. In this embodiment, the fluid is a liquid, but it may alternatively be a gas. The release pin 41 is in the form of a solid rod with a radial hole 41a, 41b at each end thereof. The lanyard 42 is a cable in this embodiment that is threaded through a first radial hole 41a of the release pin 41 and formed in a loop 42a with a joining element 42b securing the end of the cable to an intermediate part thereof to form the loop 42a. The R-clip 43 is an R-shaped spring clip that is receivable in the other radial hole 41b of the release pin 41.

The valve piston 5 is substantially cylindrical in shape with a tapered upstream end 50, first and second circumferential flanges 51, 52 adjacent the tapered end 50 between which flanges 51, 52 is defined a circumferential groove 53 that receives an O-ring seal 54. The valve piston 5 also includes a third, central circumferential flange 55 having a shallower depth or thickness to the first and second flanges 51, 52. Each of the second flange 52 and the third flange 55 includes a respective tapered downstream face 52a, 55a.

The pipe fitting 6 includes a first threaded end 60 for connection with the body 2 and a second threaded end 61 for connection with a pressurised vessel (not shown) directly or via a pipe (not shown) in fluid communication therewith. Each of the threaded ends 60, 61 is cylindrical with threads on its circumferential surface. The pipe fitting 6 also includes a hexagonal flange 62 and an O-ring seal 63 captivated between the threads of the first end 60 and the flange 62 for sealing with the inlet 23a of the body. The flange 62 provides flats 62a for cooperation with a spanner (not shown) for tightening the pipe fitting 6.

In an assembled condition, the cylindrical portion 31 of the end cap 3 is received within the tubular end portion 26 of the body such that their respective radial bores 31a, 26a are aligned. The manual release pin 41 is received within the radial bores 31a, 26a and the R-clip 43 is engaged within the second axial hole 41b to prevent inadvertent removal of the pin 41. The valve piston 5 is received within the axial bore 23 of the body 2 with its tapered end 50 within the threaded inlet 23a and the tapered downstream faces 52a, 55a of the second and third flanges 52, 55 facing the end cap 3. The frangible bulb 40 is received between the valve piston 5 and the end cap 3 such that its first, hemispherical end 40a abuts the manual release pin 41 and the projection 40b abuts the downstream end of the piston 5. The first end 60 of the pipe fitting 6 is threadedly engaged with the threaded inlet 23a and in sealing engagement therewith by virtue of the O-ring seal 63. The valve piston 5 is therefore captivated between the frangible bulb 40 and the pipe fitting 6.

In use, the second threaded end 61 of the pipe fitting 6 is fluidly connected to a pressurised vessel (not shown) directly or via a pipe (not shown). The nozzle assembly 1 extends into and is secured to a floor of the boot or trunk of a motorsport vehicle by a pair of mounting screws 7 that threadedly engage respective threaded holes (not shown) in the flat portion 20a of the body 2. The provision of a base portion 20a for securing to a site of use which is not co-aligned with the inlet allows the nozzle assembly to maintain a low profile.

The pressurised medium within the vessel (not shown) urges the valve piston 5 against the frangible bulb 40, which in turn is urged against the manual release pin 41. The position of the valve piston 5 within the body 2 is such that the O-ring seal 54 is between the inlet 23a and the outlets 24a, 24b, 24c, thereby blocking fluid communication therebetween.

When the environmental conditions of the area surrounding the nozzle assembly 1 reach a predetermined temperature that is indicative of a fire, the fluid in the frangible bulb 40 expands to create an internal pressure that causes the bulb 40 to break. This releases the piston 5, allowing the pressurised medium within the vessel (not shown) to force the piston 5 into the axial bore 23 of the body 2 and to an open position, where it abuts the manual release pin 41 with the O-ring seal 54 beyond the fluid connection between the inlet 23a and the outlets 24a, 24b, 24c. Thus, fluid communication between the inlet 23a and the outlets 24a, 24b, 24c is open and the pressurised medium is expelled out of the outlets 24a, 24b, 24c in multiple directions to extinguish the fire.

In the event of emergency, for example where a fire is present or suspected, but where the frangible bulb 40 has not broken a user (not shown) may alternatively remove the R-clip 43 manually and pull the lanyard 42 to remove the manual release pin 41 from the body 2. Thus, the frangible bulb 40 is forced by the valve piston 5, under the influence of the pressurised medium, against the end cap 3 causing it to break. This allows the valve piston 5 to move to the open position and the extinguishing medium to be expelled out of the outlets 24a, 24b, 24c in multiple directions as described above.

It will be appreciated by those skilled in the art that several variations to the aforementioned embodiments are envisaged without departing from the scope of the invention. For example, the body 2 may be of any suitable shape and in particular it may be selected to optimise the delivery of extinguishing medium based on the position of the nozzle assembly 1 in the vehicle. The nozzle assembly 1 may be configured for installation in any application, which need not be in a vehicle. The frangible bulb 40 may be replaced with any suitable means, for example a different type of frangible element or a manual release means, or even be omitted in some embodiments. The valve piston 5 may be urged, e.g. toward the open position, by some other urging or biasing means, e.g. a resilient biasing means such as a spring, different from the pressurised medium within the vessel (not shown). In some embodiments, the valve piston 5 may be configured to be urged toward the closed position. The outlets 24a, 24b, 24c need not be configured as shown and described and may include more or less outlets 24a, 24b, 24c, which may extend about the entire periphery or more or less of the periphery of the body 2. The manual release pin 41 may be replaced with any other suitable means or may be omitted altogether.

It is also envisaged that the outlets 24a, 24b, 24c may be configured to extend at least in part tangentially, with at least part of the body 2 mounted to be rotatable about the axis of the axial bore 23. Thus, when the valve piston 5 moves to the open position the extinguishing medium is expelled from the outlets 24a, 24b, 24c tangentially, which causes the rotatable part of the body 2 to rotate, thereby providing a more effective distribution.

It will also be appreciated by those skilled in the art that any number of combinations of the aforementioned features and/or those shown in the appended drawings provide clear advantages over the prior art and are therefore within the scope of the invention described herein.

1. A nozzle assembly for controlling the release or delivery of a fluid or other medium from a vessel, the nozzle assembly comprising a body having longitudinal and latitudinal dimensions and having an inlet and plural outlets, a release mechanism and valve means operable to selectively open or close fluid communication between the inlet and the outlets, wherein the valve means is biased, in use, toward an open position or condition such that operation of the release mechanism causes or permits the valve means to move or change to the open position or condition, fluid being flowable, with the valve means in the open position or condition, from the inlet to the outlets and flowing from the outlets in different directions to define a flow or spray pattern which subtends an angle of less than 360° in both the longitudinal and latitudinal directions.

2. The nozzle assembly according to claim 1, wherein the release mechanism comprises an abutment movable or changeable between a deployed condition in which the valve means is biased thereagainst and a released condition in which the valve means is able to open.

3. The nozzle assembly according to claim 2, wherein the abutment comprises a frangible element against which the valve means is biased such that when the frangible element is broken or severed, in use, the valve means is permitted to move or change to the open position or condition, wherein the frangible element is preferably configured to break or sever when it is exposed to a predetermined temperature.

4. The nozzle assembly according to claim 2, wherein the abutment comprises a removable release member.

5. The nozzle assembly according to claim 3, wherein the abutment comprises a removable release member against which the frangible element abuts.

6. The nozzle assembly according to claim 5, wherein the removable release member comprises a manual actuator.

7. The nozzle assembly according to claim 3, wherein the frangible element comprises a frangible bulb containing an expandable fluid.

8. The nozzle assembly according to claim 1, wherein the valve means is configured to be biased, in use, toward an open position or condition by a pressurised fluid or other medium contained within a vessel to which the nozzle assembly is connectable.

9. The nozzle assembly according to claim 1, wherein the valve means is configured to be biased, in use, toward an open position or condition by a resilient biaser.

10. The nozzle assembly according to claim 1, wherein the plural outlets are arranged in plural arrays, each of the arrays being distributed at a different longitudinal location.

11. The nozzle assembly according to claim 10, wherein the outlets in an array are distributed at different latitudinal locations.

12. The nozzle assembly according to claim 10, wherein the arrays comprise different numbers of outlets.

13. The nozzle assembly according to claim 10, wherein the arrays comprise the same number of outlets.

14. The nozzle assembly according to claim 10, wherein the outlets in one or more arrays provide, in use, a greater fluid throughput rate than the outlets in one or more of the other arrays.

15. The nozzle assembly according to claim 1, wherein an axial passage connects the inlet to the outlets, and two or more of the outlets extend at least in part in a radial direction with respect to the axial passage and are configured to release or deliver, in use, the fluid or other medium in different radial directions.

16. The nozzle assembly according to claim 1, wherein the valve means comprises one or more valves.

17. The nozzle assembly according to claim 1 in combination with a vessel containing a pressurised fluid or medium, wherein the nozzle assembly is in fluid communication with the vessel.

18. The combination according to claim 17, wherein the fluid or medium comprises a fire extinguishing fluid or medium, the combination comprising a fire extinguisher.

19. A nozzle assembly for controlling the release or delivery of a fluid or other medium from a vessel, the nozzle assembly comprising a body having a base and a periphery, an inlet and plural outlets extending into and out of the periphery, the base being securable to a site of use, a release element or mechanism and valve means operable to selectively open or close fluid communication between the inlet and the outlets, wherein the valve means is biased, in use, toward an open position or condition such that operation of the release element or mechanism causes or permits the valve means to move or change to the open position or condition, and wherein the plural outlets cause fluid flowing therefrom to generate a flow pattern which extends away from the base in at least three directions.

20. A nozzle assembly for controlling the release or delivery of a fluid or other medium from a vessel, the nozzle assembly comprising an inlet, one or more outlets, a release element or mechanism and one or more valves operable to selectively open or close fluid communication between the inlet and the outlet, wherein at least one of the valves is biased, in use, toward an open or a closed position or condition such that operation of the release element or mechanism causes or allows or permits the biased valve or valves to move or change to the position or condition toward which it is or they are biased.
